(19) United States
(12) Patent Application Publication
(10) Pub. No.: US 2013/0150923 A1
(43) Pub. Date: Jun. 13, 2013

(54) Electrical Stimulation Device

(71) Applicants: Guntram Schnetz, Biedermannsdorf (AT); Friedrich Netauschek, Hoflein an der Donau (AT)

(72) Inventors: Guntram Schnetz, Biedermannsdorf (AT); Friedrich Netauschek, Hoflein an der Donau (AT)

(73) Assignee: BIEGLER GMBH, Mauerbach (AT)

(21) Appl. No.: 13/806,242

(22) PCT Filed: May 9, 2011
(86) PCT No.: PCT/AT11/00218

§ 371 Date: Feb. 26, 2013

(30) Foreign Application Priority Data
Jun. 30, 2010 (AT) GM 414/2010

(51) Int. Cl. A61H 39/00

(52) U.S. Cl. CPC A61H 39/002
USPC 607/59; 607/72

(57) ABSTRACT

The invention relates to an electrical stimulation device (1) with a stimulator (2), containing a generator (3) for generating electrical stimulation impulses with defined stimulation parameters, and a voltage supply (4) for supplying the generator (3) with electrical energy, and with at least two needle electrodes (5) for insertion into the skin surface of an area that is to be stimulated, which needle electrodes (5) are connected to the stimulator (2). According to the invention, the needle electrodes (5) are arranged in a common electrode housing (6) and are connected to the stimulator (2), preferably releasably, via a line (7).

### CROSS-REFERENCE TO RELATED APPLICATIONS

This application is the National Stage of International Application No. PCT/AT2011/000218, filed on 9 May 2011 claiming the priority of AT GM 414/2010, filed on 30 Jun. 2010, the content of each of which is incorporated by reference herein.

### TECHNICAL FIELD OF THE INVENTION

The invention relates to an electrical stimulation device including a stimulator containing a generator for generating electrical stimulation pulses with defined stimulation parameters and a voltage supply for supplying the generator with electrical energy, and at least two needle electrodes for insertion into the skin surface of an area to be stimulated, which needle electrodes are connected to the stimulator.

### REFERENCE TO SEQUENCE LISTING

None.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

The electrical stimulation device in question is, in particular, applicable in the electrical acupuncture therapy of humans and even animals. The device is, in particular, suitable for using the electrical stimulation of acupuncture points in the region of the ear. Applications range from pain management to wound healing, to therapies of circulatory disorders, e.g. in diabetics.

An electrical stimulation device of the present type is, for instance, known from AT 395 106 B and EP 1 335 774 B1. There, the stimulator is glued to the skin surface by a pressure-sensitive adhesive in the vicinity of the area to be stimulated, and the needle electrodes, which are fixedly connected to the stimulator, are placed on the desired points. Also the needle electrodes can be fixed to the skin surface by appropriate adhesive elements. Especially during extended treatment periods, the stimulator or the needle electrodes may frequently detach, thus interrupting the electrical stimulation. It is, in particular, generally not possible to successfully fix the stimulator, which is larger and heavier than the needle electrodes, to the skin surface of a patient over extended periods of up to several days.

### SUMMARY OF THE INVENTION

The aim of the present invention is to provide an above-identified electrical stimulation device that avoids the drawbacks of known stimulation devices and allows for simple and quick application and safe stimulation even over several days. The device is to be producible as simply and cost-effectively as possible so as to even enable its economical application as a disposable product.

The object of the invention is achieved in that the needle electrodes are arranged in a common electrode housing and connected to the stimulator via a line. In accordance with the invention, the mass electrode and the at least one stimulation electrode are thus arranged in a common electrode housing, which facilitates and accelerates its application, i.e. insertion into the skin surface, yet also improve the adherence to the skin surface or attachment to the skin surface. As a function of the respective application, at least one mass electrode and at least one stimulation electrode are arranged in the electrode housing. The needle electrodes are likewise adapted to the respective application, yet also to the patient undergoing treatment, or the animal undergoing treatment. For an electrical acupuncture in the region of the ear of a human being, the needle electrodes have diameters of a few tenths of millimeters and insertion depths of few millimeters. In order to achieve a length compensation and an increase in the mobility of a patient, it may be advantageous to configure the line as a coiled cable.

In order to be able to achieve the detachment of the needle electrodes from the stimulator and, for instance, take off the stimulator during showering, it is advantageous if the line is provided with at least one plug for the detachable connection to a respective socket provided on the stimulator or on the electrode housing. This will enable the patient or a nursing attendant to simply separate the electrode housing from the stimulator and reconnect it thereto. The line can be fixedly connected to the electrode housing, and the plug can be fastened to the end of the line, and the stimulator can be equipped with an appropriate socket. It is also possible to fixedly connect the line to the stimulator, and to arrange the plug on the end of the line and the associated socket on the electrode housing.

In an advantageous manner, the needle electrodes are arranged on a common board within the electrode housing. A suitable board will thus comprise a number of openings that corresponds to the number of needle electrodes, for inserting the needle electrodes, and conductive tracks that are connected to connecting points for the line, for connecting to the stimulator or a respective socket in the electrode housing.

In an advantageous manner, the needle electrodes are connected to the board by a conductive adhesive. This will enable rapid and cost-effective production.

The line can be connected to the board by a solder or screw connection. Solder connections are particularly advantageous with especially small-structured electrode housings.

The needle electrodes are made of an electrically conductive material, in particular a metal such as titanium, stainless steel or the like. The insertion electrodes can be produced by lathing. In addition to metals, conductive synthetics are also conceivable for the production of the needle electrodes, the materials having to exhibit the respective biocompatibility and avoid allergic reactions.

The electrode housing is advantageously designed to be water-proof, which will enable the temporary separation of the electrode housing from the stimulator, and hence the patient to even take, for instance, a shower.

In order to improve the fixation of the electrode housing to the skin surface, a fastening element, preferably an adhesive element, may be provided. Besides the adhesive element, other fastening methods, e.g. via elastic bands or the like, are conceivable as a function of the location of stimulation and the patient or animal, respectively.

The fastening element, which is preferably designed as an adhesive element, can already be integrated in the electrode housing. This will further facilitate its application, since the patient or the physician does not need to position the fastening element on the electrode housing, but merely needs to pull off, for instance, a cover foil from an adhesive layer.

On the side of the electrode housing opposite the needle electrodes, a handling element may be arranged to facilitate the application of the electrode housing, and the needle electrodes disposed therein, on the desired site, e.g. on the ear.

Such a handling element can be formed by a substantially cylindrical handle, which is preferably produced in one piece with the electrode housing. Such a handling element can be very simply produced by injection molding, in particular with usual electrode housings made of synthetic material.

The handling element can also be formed by a depression or hole in the electrode housing, in which a respectively designed counter-piece of a handling instrument can be arranged. In this respect, cylindrical, spherical or conical depressions are, for instance, applied.

Since the needle electrodes are inserted into the skin surface, it will be advantageous if the electrode housing with the needle electrodes contained therein is arranged in a package, optionally together with the line fastened to the electrode housing. Contamination will thus be avoided. The components are preferably sterilized before or after packaging.

In order to achieve an elevated wearing comfort of the stimulation device, the stimulator can be coupled to a lanyard, which can be worn around the neck like a halter neck, or over the shoulder. The lanyard can at least partially be configured as a line for connecting to the electrode housing and provided with a socket or a plug for connecting to the line attached to the electrode housing. Other options for fastening the stimulator, for instance by the aid of fastening elements in the form of ear clips, can also be envisaged.

The generator of the stimulator is preferably configured to generate stimulation pulses having a repetition frequency of 0.5 to 100 Hz, preferably 1 Hz, and a duty cycle of 10 to 90%, preferably 50%. These stimulation parameters have turned out to be preferred in pain therapy or wound healing.

Since the impedance of the skin comprises large variations, it will be advantageous if the stimulation pulses are generated at a constant current amplitude. To this end, the stimulator comprises an appropriate control device. The control device may be comprised of a suitable microcontroller.

Where the control device is coupled to operating elements for changing the stimulation parameters, manual adjustment and change of the stimulation parameters may be provided. Where no operating elements are provided, the respective adjustment of the stimulation parameters can be performed by programming the control device. To this end, the stimulator preferably comprises a suitable interface for connecting to a control computer.

A switch or the like can be provided to activate the stimulator. Alternatively, the activation can, for instance, also be realized by removing an insulator on the battery constituting the voltage supply.

In order to give a feedback on the operation of the stimulation device to the patient or the physician, an operation indicator, e.g. a light-emitting diode, can be provided in the stimulator. In addition to an optical operation indicator, an acoustic indicator of the proper operation or proper start-up can also be provided.

Advantageously, a memory for recording the stimulation parameters as a function of time is provided to enable the performance of a quality control check or check of the proper operation.

The present invention also relates to an above-identified electrode housing including at least two needle electrodes with optional lines to connect to the stimulator. Such an electrode housing can also be marketed separately, unless the stimulator is sold together with the electrode and designed as a disposable product. If the stimulation device is designed as a disposable product, the stimulator is packed together with the electrode housing and the needle electrodes arranged therein, whereby, in particular, the needle electrodes will be protected from contamination, e.g. by a separately provided blister package.

### BRIEF DESCRIPTION OF THE DRAWINGS

The present invention will be explained in more detail by way of the accompanying drawings. Therein:

FIG. 1 is a schematic view of an embodiment of an electrical stimulation device;

FIG. 2 is a perspective view of an embodiment of an electrode housing comprising two needle electrodes and a line for connecting to the stimulator;

FIG. 3 is a sectional illustration through the electrode housing according to FIG. 2 in the region of a needle electrode;

FIG. 4 is a top view of an electrode housing having an integrated fastening element;

FIG. 5 is a block diagram of an embodiment of a stimulator;

FIG. 6 depicts a further embodiment of a stimulation device; and

FIG. 7 shows various embodiments of a handling element on the electrode housing.

### DETAILED DESCRIPTION OF THE INVENTION

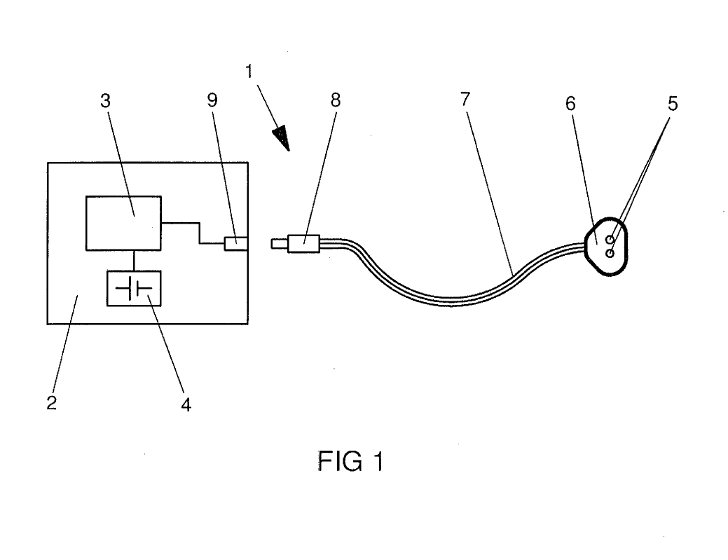

FIG. 1 depicts an electrical stimulation device 1 for, in particular, an electrical acupuncture therapy in the region of the ear of a human being. The stimulation device 1 includes a stimulator 2 containing a generator 3 for generating stimulation pulses with defined stimulation parameters, i.e. a defined voltage or a defined current, a defined duration, a defined repetition frequency and a defined duty cycle etc. To supply the components of the stimulator 2 with electrical energy, a voltage supply 4 is provided, which is preferably formed by a suitable battery or an accumulator. The electrical pulses generated in the generator 3 of the stimulator 2 are delivered via at least two needle electrodes 5, which are inserted into the skin surface in the area to be stimulated. They comprise at least one mass electrode and at least one stimulation electrode. The needle electrodes 5 are arranged in a common electrode housing 6 and connected to the stimulator 2 by an appropriate line 7. Due to the joint arrangement of all needle electrodes 5 in a common electrode housing 6, simple application will be enabled, and a better support of the needle electrodes 5, in particular at extended therapy intervals, and also a defined distance between the individual needle electrodes 5 will be achieved. The line 7 for connecting the needle electrodes 5 to the stimulator 2 can be fixedly, i.e. inseparably, or even detachably arranged. In order to enable simple detachment and connection, it is advantageous if at least one appropriate plug 8 is arranged on the line 7. Depending on whether the line 7 is fixedly connected to the electrode housing 6 or to the stimulator 2, a socket 9 associated with the plug 8 is provided on the stimulator 2 or on the electrode housing 6, respectively, (not illustrated). If the line 7 is designed as a coiled cable, a length compensation between the electrode housing 6 and the stimulator 2, and an enhanced mobility, can be achieved.

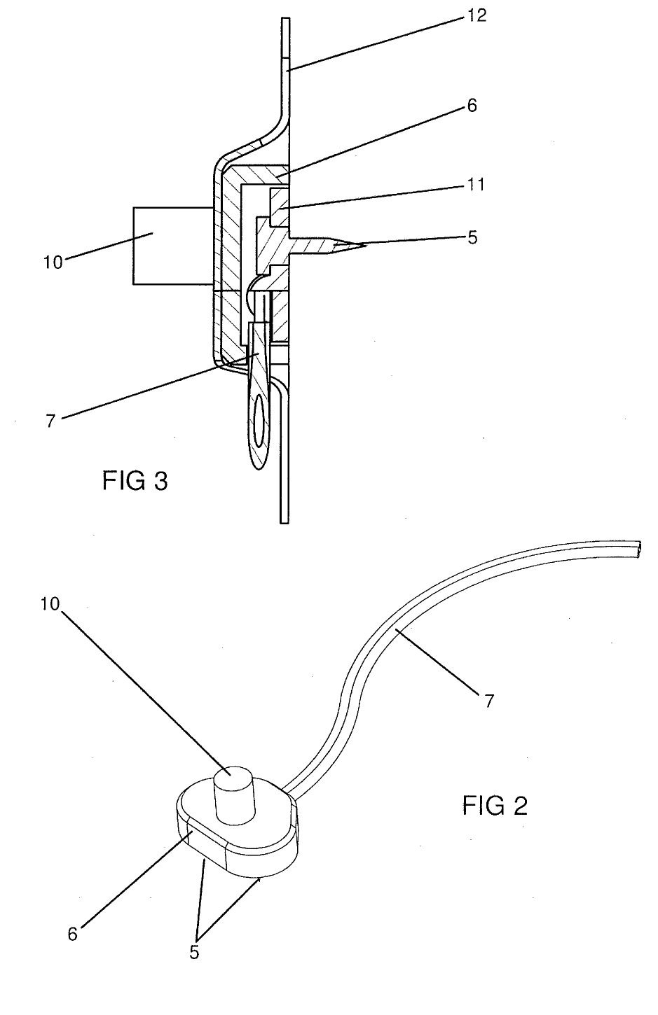

FIG. 2 is a perspective view of a variant embodiment of an electrode housing 6 with needle electrodes 5 arranged therein, and a fixedly connected line 7. The electrode housing 6, which is preferably made of a synthetic material and is preferably designed to be water-proof, may comprise a handling element 10 on the side opposite the needle electrodes 5, which handling element will facilitate the application of the needle electrodes 5 on the desired skin area to be stimulated. In the illustrated example, the handling element 10 is formed by a substantially cylindrical handle, yet it may be designed in any other manner as a function of the use and size of the electrode housing 6 (cf. FIG. 7). The component depicted in FIG. 2 can be arranged in a preferably sterile package (not illustrated) so as to prevent any contamination of the needle electrodes 5.

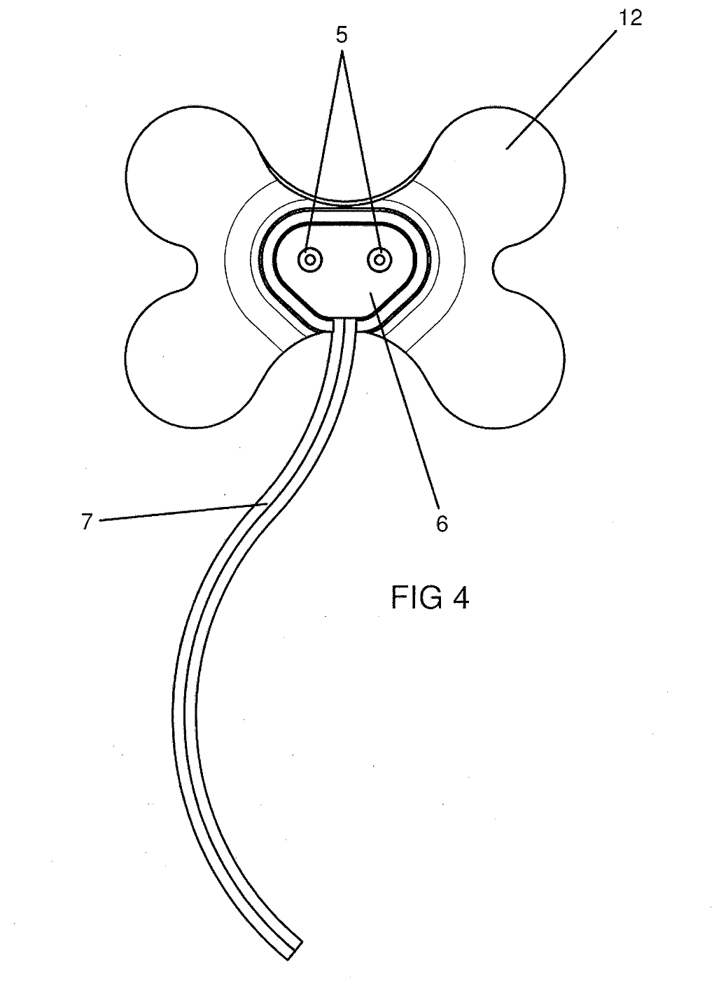

As is apparent from the sectional illustration according to FIG. 3, a board 11 on which the needle electrodes 5 are mounted is arranged in the electrode housing 6. The needle electrodes 5 can, for instance, be simply connected to the board 11 by a conductive adhesive. The line 7 is likewise connected to the board 11, either by a solder joint or by a screw connection, the conductive tracks of said board safeguarding the electrical connection to the needle electrodes 5. Above the electrode housing 6, a fastening element 12 in the form of an adhesive foil is visible, by the aid of which the electrode housing 6 can be fixed to the skin surface.

FIG. 4 is a top view showing a further embodiment of an electrode housing 6 accommodating two needle electrodes 5, with a fastening element 12 comprised of an adhesive foil with protruding tabs being integrated in the electrode housing 6. Fixation of the needle electrodes 5 can be performed by simply removing a cover foil (not illustrated) from the fastening element and affixing to the skin surface. Instead of integrating the fastening element 12, which is preferably comprised of an adhesive element, a plaster-like adhesive strip can also be placed over the electrode housing 6. In this case, an optionally provided handling element 10 can be inserted through a prefabricated hole in said plaster.

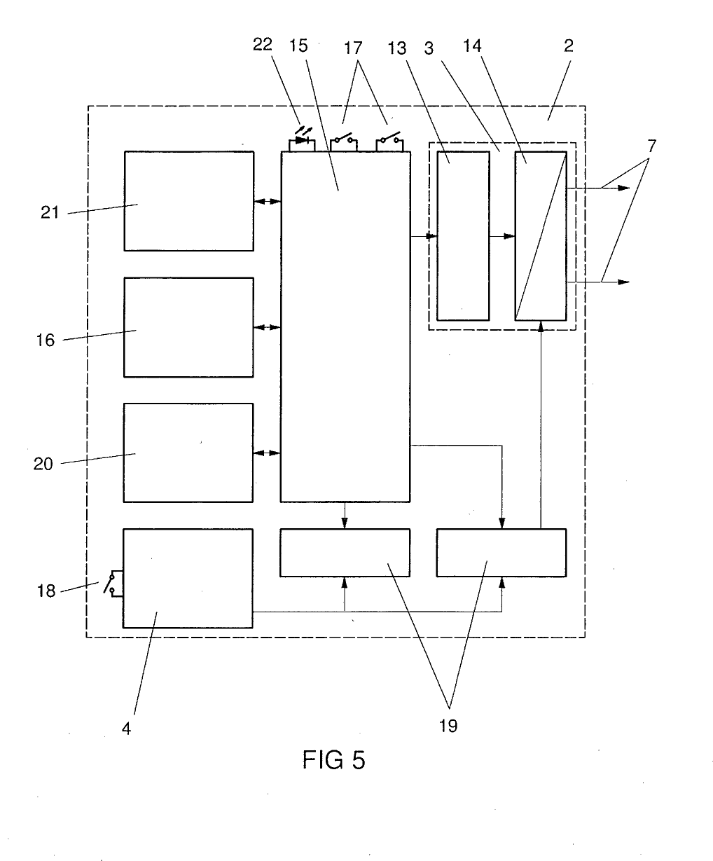

FIG. 5 finally depicts a block diagram of an embodiment of a stimulator 2 of the electrical stimulation device 1. Therein, the generator 3 for generating electrical stimulation pulses is comprised of a digital/analog converter 13 and a voltage/current converter 14. The needle electrodes 5 (not illustrated) are connected to the stimulator 2 via lines 7. The voltage supply 4 is preferably formed by a battery. The actuation of the generator 3, and the fixation of the stimulation parameters and control of the stimulation procedure, are effected via a control device 15. The control device 15 is preferably comprised of a suitable microcontroller. The control device can be programmed, and its parameters can be changed, via an interface 16. A change in the stimulation parameters can also be effected manually by the aid of appropriate operating elements 17 coupled to the control device 15. The current amplitude of the stimulation pulses can, for instance, be adjusted and changed via operating elements 17, e.g. buttons. Activation of the stimulator 2 and the voltage supply 4 provided therein can be effected via a switch 18. In accordance with the invention, stimulation pulses are delivered to the lines 7 connected to the needle electrodes 5 at constant current amplitudes in order to be more independent of the strongly varying impedance of the skin. To this end, appropriate control units 19, which are again connected to the voltage/current converter 14, are coupled to the control device 15.

Furthermore, an appropriate clock generator 20, which may, for instance, be formed by a quartz crystal, is coupled to the control device 15. If the stimulator 2 comprises a memory 21, the stimulation parameters can be recorded as a function of time for subsequent examinations or for quality control. The memory 21 can be read out by an appropriate computer via the interface 16.

To indicate the proper functioning of the stimulation device 1 and the stimulator 2, respectively, an appropriate operation indicator 22 can be provided, which may, for instance, be formed by a light-emitting diode.

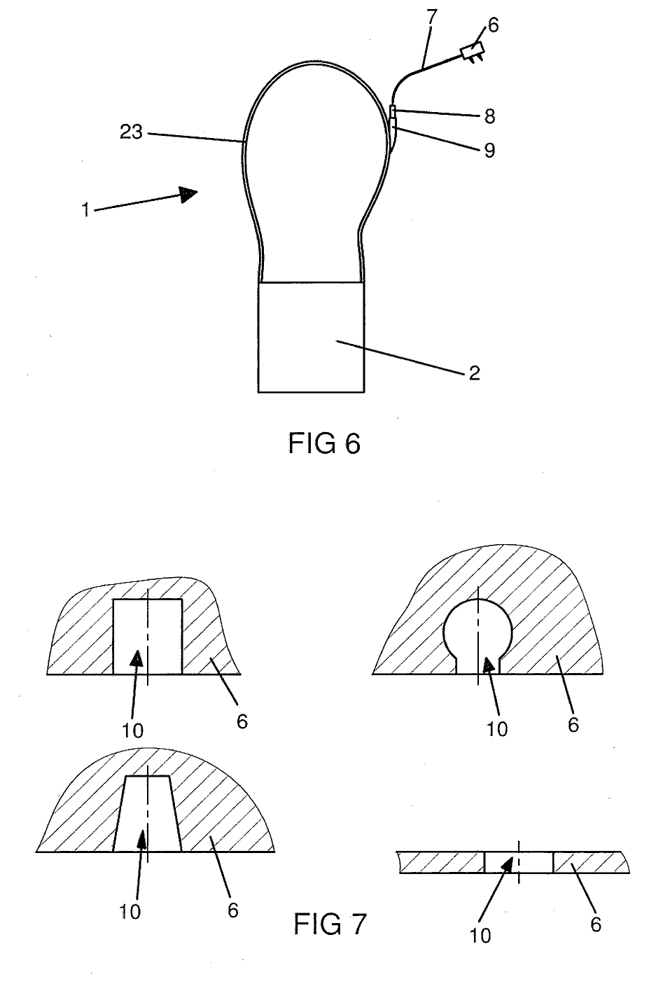

FIG. 6 depicts a further embodiment of a stimulation device 1, wherein the stimulator 2 is provided with a lanyard 23. Such lanyard 23 can be arranged as a halter neck around the neck of a patient or his/her shoulder, enabling a comfortable wear of the stimulator 2. The lanyard can at least partially be designed as a line 7 for connecting to the electrode housing 6 with the needle electrodes 5 integrated therein. In order to enable the detachment of the stimulator 2, for instance during showering, without removing the needle electrodes 5, it is advantageous if the electrode housing 6 is detachably connected to the stimulator 2 by appropriate plugs 8 and sockets 9. For an electrical puncturing in the region of the ear, an embodiment in which the stimulator 2 is connected to a fastening element in the form of an ear clip will be suitable. This will enable the stimulator 2 to be arranged on the earlobe like a piece of jewelry and connected to the electrode housing 6 with integrated needle electrodes 5 (not illustrated) via an appropriate line.

As already described in FIG. 2, the electrode housing 6 may comprise a handling element 10 on the side opposite the needle electrodes 5. FIG. 7 illustrates further embodiments of such a handling element 10 in the form of different depressions or holes provided in the electrode housing 6. Such cylindrically, spherically or conically designed depressions, or accordingly configured holes, in the electrode housing 6 allow for the placement of an accordingly configured handling instrument (not illustrated) and the placement, and removal, of the electrode housing 6 with the needle electrodes 5 on the desired stimulation area. In particular with a conical or frustoconical depression as said handling element 10, self-locking of a respective cone or frustum, respectively, on a handling instrument (not illustrated) will be achieved.

What is claimed is:

1. An electrical stimulation device (1) including a stimulator (2) containing a generator (3) for generating electrical stimulation pulses with defined stimulation parameters and a voltage supply (4) for supplying the generator (3) with electrical energy, and at least two needle electrodes (5) for insertion into the skin surface of an area to be stimulated, which needle electrodes (5) are connected to the stimulator (2), characterized in that the needle electrodes (5) are arranged in a common electrode housing (6) at a defined mutual distance and connected to the stimulator (2) via a line (7), that a handling element (10) is arranged on the side of the electrode housing (6) opposite the needle electrodes (5), that the electrode housing (6) is designed to be water-proof, and that the stimulator (2) comprises a control device (15) for generating stimulation pulses having a constant current amplitude, wherein at least one of the needle electrodes (5) is designed as a mass electrode and at least another one of the needle electrodes (5) is designed as a stimulation electrode.

2. A stimulation device (1) according to claim 1, characterized in that the line (7) is provided with at least one plug (8) for the detachable connection to a respective socket (9) provided on the stimulator or on the electrode housing (6).

3. A stimulation device (1) according to claim 1, characterized in that the needle electrodes (5) are arranged on a common board (11) within the electrode housing (6).

4. A stimulation device (1) according to claim 3, characterized in that the needle electrodes (5) are connected to the board (11) by a conductive adhesive.

5. A stimulation device (1) according to claim 3, characterized in that the line (7) is connected to the board (11) by a solder or screw connection.

6. A stimulation device (1) according to claim 1, characterized in that the needle electrodes (5) are made of an electrically conductive material, in particular a metal such as titanium, stainless steel or the like.

7. A stimulation device (1) according to claim 1, characterized in that a fastening element (12), preferably an adhesive element, is provided for fastening the electrode housing (6) to the skin surface of the area to be stimulated.

8. A stimulation device (1) according to claim 7, characterized in that the fastening element (12), preferably adhesive element, is integrated in the electrode housing (6).

9. A stimulation device (1) according to claim 1, characterized in that the handling element (10) is formed by a substantially cylindrical handle.

10. A stimulation device (1) according to claim 1, characterized in that the handling element (10) is formed by a depression or hole in the electrode housing (6).

11. A stimulation device (1) according to claim 1, characterized in that the electrode housing (6) with the needle electrodes (5) contained therein is arranged in a preferably sterile package, optionally together with the line (7).

12. A stimulation device (1) according to claim 1, characterized in that the stimulator (2) is coupled to a lanyard (23).

13. A stimulation device (1) according to claim 1, characterized in that the generator (3) is configured to generate stimulation pulses having a repetition frequency of 0.5 to 100 Hz, preferably 1 Hz, and a duty cycle of 10 to 90%, preferably 50%.

14. A stimulation device (1) according to claim 1, characterized in that the control device (15) is coupled to operating elements (17) for changing the stimulation parameters.

15. A stimulation device (1) according to claim 1, characterized in that a switch (18) is provided to activate the stimulator (2).

16. A stimulation device (1) according to claim 1, characterized in that an operation indicator (22) is provided in the stimulator (2).

17. A stimulation device (1) according to claim 1, characterized in that a memory (21) for recording the stimulation parameters as a function of time is provided.
